(19) United States
(12) Patent Application Publication
(10) Pub. No.: US 2026/0180753 A1
(43) Pub. Date: Jun. 25, 2026

(54) DEMODULATION REFERENCE SIGNAL SEQUENCE INITIALIZATION OFFSET VALUES

(71) Applicant: Nokia Technologies Oy, Espoo (FI)

(72) Inventors: Juha Pekka KARJALAINEN, Oulu (FI); Timo KOSKELA, Oulu (FI); Sami-Jukka HAKOLA, Oulu (FI); Keeth Saliya Jayasinghe LADDU, Espoo (FI)

(21) Appl. No.: 19/125,883

(22) PCT Filed: Sep. 22, 2023
(86) PCT No.: PCT/EP2023/076186

§ 371 Date: Apr. 30, 2025

(30) Foreign Application Priority Data
Nov. 4, 2022 (GB) 2216428.9

(51) Int. Cl. H04L 5/00; H04W 72/21

(52) U.S. Cl. CPC H04L 5/0051; H04W 72/21

(57) ABSTRACT

Disclosed is a method comprising receiving, from a user device via a first network node, a first uplink transmission based on a first DMRS sequence initialization offset value, wherein the first DMRS sequence initialization offset value is based on at least one of: a first control resource set pool index, CORESETPoolIndex, value related to a first downlink control information, DCI, a first transmission configuration indicator, TCI, state, or a first physical uplink shared channel, PUSCH, configuration; and receiving, from the user device via a second network node, a second uplink transmission based on a second DMRS sequence initialization offset value, wherein the second DMRS sequence initialization offset value is based on at least one of: a second CORESETPoolIndex value related to a second DCI, a second TCI state, or a second PUSCH configuration, and wherein the first uplink transmission and the second uplink transmission overlap at least partially in time.

### FIELD

The following example embodiments relate to wireless communication.

### BACKGROUND

Some wireless communication networks are capable of utilizing multiple transmission-reception point operation. There is challenge in how to enable simultaneous transmissions to multiple transmission-reception points.

### BRIEF DESCRIPTION

The scope of protection sought for various example embodiments is set out by the independent claims. The example embodiments and features, if any, described in this specification that do not fall under the scope of the independent claims are to be interpreted as examples useful for understanding various embodiments.

According to an aspect, there is provided an apparatus comprising at least one processor, and at least one memory storing instructions that, when executed by the at least one processor, cause the apparatus at least to: determine a first demodulation reference signal, DMRS, sequence initialization offset value for a first network node, wherein the first DMRS sequence initialization offset value is determined based on at least one of: a first control resource set pool index, CORESETPoolIndex, value related to a first downlink control information, DCI, a first transmission configuration indicator, TCI, state, or a first physical uplink shared channel, PUSCH, configuration; determine a second DMRS sequence initialization offset value for a second network node, wherein the second DMRS sequence initialization offset value is determined based on at least one of: a second CORESETPoolIndex value related to a second DCI, a second TCI state, or a second PUSCH configuration; perform, based on the first DMRS sequence initialization offset value, a first uplink transmission to the first network node; and perform, based on the second DMRS sequence initialization offset value, a second uplink transmission to the second network node, wherein the first uplink transmission and the second uplink transmission overlap at least partially in time.

According to another aspect, there is provided an apparatus comprising: means for determining a first demodulation reference signal, DMRS, sequence initialization offset value for a first network node, wherein the first DMRS sequence initialization offset value is determined based on at least one of: a first control resource set pool index, CORESETPoolIndex, value related to a first downlink control information, DCI, a first transmission configuration indicator, TCI, state, or a first physical uplink shared channel, PUSCH, configuration; means for determining a second DMRS sequence initialization offset value for a second network node, wherein the second DMRS sequence initialization offset value is determined based on at least one of: a second CORESETPoolIndex value related to a second DCI, a second TCI state, or a second PUSCH configuration; means for performing, based on the first DMRS sequence initialization offset value, a first uplink transmission to the first network node; and means for performing, based on the second DMRS sequence initialization offset value, a second uplink transmission to the second network node, wherein the first uplink transmission and the second uplink transmission overlap at least partially in time.

According to another aspect, there is provided a method comprising: determining a first demodulation reference signal, DMRS, sequence initialization offset value for a first network node, wherein the first DMRS sequence initialization offset value is determined based on at least one of: a first control resource set pool index, CORESETPoolIndex, value related to a first downlink control information, DCI, a first transmission configuration indicator, TCI, state, or a first physical uplink shared channel, PUSCH, configuration; determining a second DMRS sequence initialization offset value for a second network node, wherein the second DMRS sequence initialization offset value is determined based on at least one of: a second CORESETPoolIndex value related to a second DCI, a second TCI state, or a second PUSCH configuration; performing, based on the first DMRS sequence initialization offset value, a first uplink transmission to the first network node; and performing, based on the second DMRS sequence initialization offset value, a second uplink transmission to the second network node, wherein the first uplink transmission and the second uplink transmission overlap at least partially in time.

According to another aspect, there is provided a computer program comprising instructions which, when executed by an apparatus, cause the apparatus to perform at least the following: determining a first demodulation reference signal, DMRS, sequence initialization offset value for a first network node, wherein the first DMRS sequence initialization offset value is determined based on at least one of: a first control resource set pool index, CORESETPoolIndex, value related to a first downlink control information, DCI, a first transmission configuration indicator, TCI, state, or a first physical uplink shared channel, PUSCH, configuration; determining a second DMRS sequence initialization offset value for a second network node, wherein the second DMRS sequence initialization offset value is determined based on at least one of: a second CORESETPoolIndex value related to a second DCI, a second TCI state, or a second PUSCH configuration; performing, based on the first DMRS sequence initialization offset value, a first uplink transmission to the first network node; and performing, based on the second DMRS sequence initialization offset value, a second uplink transmission to the second network node, wherein the first uplink transmission and the second uplink transmission overlap at least partially in time.

According to another aspect, there is provided a computer readable medium comprising program instructions which, when executed by an apparatus, cause the apparatus to perform at least the following: determining a first demodulation reference signal, DMRS, sequence initialization offset value for a first network node, wherein the first DMRS sequence initialization offset value is determined based on at least one of: a first control resource set pool index, CORESETPoolIndex, value related to a first downlink control information, DCI, a first transmission configuration indicator, TCI, state, or a first physical uplink shared channel, PUSCH, configuration; determining a second DMRS sequence initialization offset value for a second network node, wherein the second DMRS sequence initialization offset value is determined based on at least one of: a second CORESETPoolIndex value related to a second DCI, a second TCI state, or a second PUSCH configuration; performing, based on the first DMRS sequence initialization offset value, a first uplink transmission to the first network node; and performing, based on the second DMRS sequence initialization offset value, a second uplink transmission to the second network node, wherein the first uplink transmission and the second uplink transmission overlap at least partially in time.

According to another aspect, there is provided a non-transitory computer readable medium comprising program instructions which, when executed by an apparatus, cause the apparatus to perform at least the following: determining a first demodulation reference signal, DMRS, sequence initialization offset value for a first network node, wherein the first DMRS sequence initialization offset value is determined based on at least one of: a first control resource set pool index, CORESETPoolIndex, value related to a first downlink control information, DCI, a first transmission configuration indicator, TCI, state, or a first physical uplink shared channel, PUSCH, configuration; determining a second DMRS sequence initialization offset value for a second network node, wherein the second DMRS sequence initialization offset value is determined based on at least one of: a second CORESETPoolIndex value related to a second DCI, a second TCI state, or a second PUSCH configuration; performing, based on the first DMRS sequence initialization offset value, a first uplink transmission to the first network node; and performing, based on the second DMRS sequence initialization offset value, a second uplink transmission to the second network node, wherein the first uplink transmission and the second uplink transmission overlap at least partially in time.

According to another aspect, there is provided an apparatus comprising at least one processor, and at least one memory storing instructions that, when executed by the at least one processor, cause the apparatus at least to: receive, from a user device via a first network node, a first uplink transmission based on a first DMRS sequence initialization offset value, wherein the first DMRS sequence initialization offset value is based on at least one of: a first control resource set pool index, CORESETPoolIndex, value related to a first downlink control information, DCI, a first transmission configuration indicator, TCI, state, or a first physical uplink shared channel, PUSCH, configuration; and receive, from the user device via a second network node, a second uplink transmission based on a second DMRS sequence initialization offset value, wherein the second DMRS sequence initialization offset value is based on at least one of: a second CORESETPoolIndex value related to a second DCI, a second TCI state, or a second PUSCH configuration, and wherein the first uplink transmission and the second uplink transmission overlap at least partially in time.

According to another aspect, there is provided an apparatus comprising: means for means for receiving, from a user device via a first network node, a first uplink transmission based on a first DMRS sequence initialization offset value, wherein the first DMRS sequence initialization offset value is based on at least one of: a first control resource set pool index, CORESETPoolIndex, value related to a first downlink control information, DCI, a first transmission configuration indicator, TCI, state, or a first physical uplink shared channel, PUSCH, configuration; and means for receiving, from the user device via a second network node, a second uplink transmission based on a second DMRS sequence initialization offset value, wherein the second DMRS sequence initialization offset value is based on at least one of: a second CORESETPoolIndex value related to a second DCI, a second TCI state, or a second PUSCH configuration, and wherein the first uplink transmission and the second uplink transmission overlap at least partially in time.

According to another aspect, there is provided a method comprising: receiving, from a user device via a first network node, a first uplink transmission based on a first DMRS sequence initialization offset value, wherein the first DMRS sequence initialization offset value is based on at least one of: a first control resource set pool index, CORESETPoolIndex, value related to a first downlink control information, DCI, a first transmission configuration indicator, TCI, state, or a first physical uplink shared channel, PUSCH, configuration; and receiving, from the user device via a second network node, a second uplink transmission based on a second DMRS sequence initialization offset value, wherein the second DMRS sequence initialization offset value is based on at least one of: a second CORESETPoolIndex value related to a second DCI, a second TCI state, or a second PUSCH configuration, and wherein the first uplink transmission and the second uplink transmission overlap at least partially in time.

According to another aspect, there is provided a computer program comprising instructions which, when executed by an apparatus, cause the apparatus to perform at least the following: receiving, from a user device via a first network node, a first uplink transmission based on a first DMRS sequence initialization offset value, wherein the first DMRS sequence initialization offset value is based on at least one of: a first control resource set pool index, CORESETPoolIndex, value related to a first downlink control information, DCI, a first transmission configuration indicator, TCI, state, or a first physical uplink shared channel, PUSCH, configuration; and receiving, from the user device via a second network node, a second uplink transmission based on a second DMRS sequence initialization offset value, wherein the second DMRS sequence initialization offset value is based on at least one of: a second CORESETPoolIndex value related to a second DCI, a second TCI state, or a second PUSCH configuration, and wherein the first uplink transmission and the second uplink transmission overlap at least partially in time.

According to another aspect, there is provided a computer readable medium comprising program instructions which, when executed by an apparatus, cause the apparatus to perform at least the following: receiving, from a user device via a first network node, a first uplink transmission based on a first DMRS sequence initialization offset value, wherein the first DMRS sequence initialization offset value is based on at least one of: a first control resource set pool index, CORESETPoolIndex, value related to a first downlink control information, DCI, a first transmission configuration indicator, TCI, state, or a first physical uplink shared channel, PUSCH, configuration; and receiving, from the user device via a second network node, a second uplink transmission based on a second DMRS sequence initialization offset value, wherein the second DMRS sequence initialization offset value is based on at least one of: a second CORESETPoolIndex value related to a second DCI, a second TCI state, or a second PUSCH configuration, and wherein the first uplink transmission and the second uplink transmission overlap at least partially in time.

According to another aspect, there is provided a non-transitory computer readable medium comprising program instructions which, when executed by an apparatus, cause the apparatus to perform at least the following: receiving, from a user device via a first network node, a first uplink transmission based on a first DMRS sequence initialization offset value, wherein the first DMRS sequence initialization offset value is based on at least one of: a first control resource set pool index, CORESETPoolIndex, value related to a first downlink control information, DCI, a first transmission configuration indicator, TCI, state, or a first physical uplink shared channel, PUSCH, configuration; and receiving, from the user device via a second network node, a second uplink transmission based on a second DMRS sequence initialization offset value, wherein the second DMRS sequence initialization offset value is based on at least one of: a second CORESETPoolIndex value related to a second DCI, a second TCI state, or a second PUSCH configuration, and wherein the first uplink transmission and the second uplink transmission overlap at least partially in time.

### LIST OF DRAWINGS

In the following, various example embodiments will be described in greater detail with reference to the accompanying drawings, in which

FIG. 1A illustrates an example of a cellular communication network;

FIG. 1B illustrates an example of a system;

FIG. 2 illustrates a signaling diagram;

FIG. 3 illustrates a signaling diagram;

FIG. 4 illustrates a signaling diagram;

FIG. 5 illustrates a flow chart;

FIG. 6 illustrates a flow chart;

FIG. 7 illustrates a flow chart;

FIG. 8 illustrates a flow chart;

FIG. 9 illustrates an example of an apparatus; and

FIG. 10 illustrates an example of an apparatus.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

In the following, different example embodiments will be described using, as an example of an access architecture to which the example embodiments may be applied, a radio access architecture based on long term evolution advanced (LTE Advanced, LTE-A), new radio (NR, 5G), beyond 5G, or sixth generation (6G) without restricting the example embodiments to such an architecture, however. It is obvious for a person skilled in the art that the example embodiments may also be applied to other kinds of communications networks having suitable means by adjusting parameters and procedures appropriately. Some examples of other options for suitable systems may be the universal mobile telecommunications system (UMTS) radio access network (UTRAN or E-UTRAN), long term evolution (LTE, substantially the same as E-UTRA), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

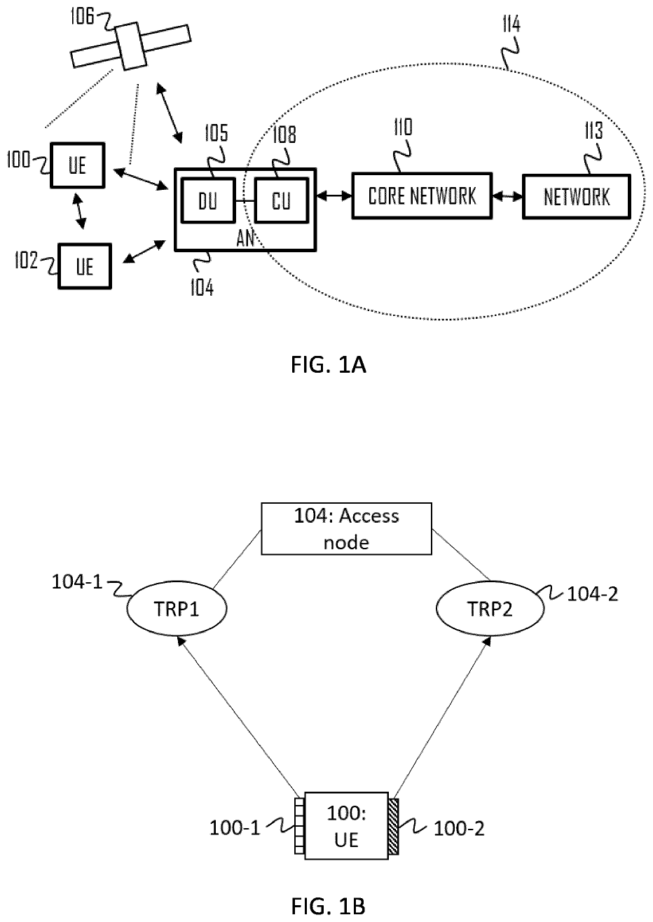

FIG. 1A depicts examples of simplified system architectures showing some elements and functional entities, all being logical units, whose implementation may differ from what is shown. The connections shown in FIG. 1A are logical connections; the actual physical connections may be different. It is apparent to a person skilled in the art that the system may also comprise other functions and structures than those shown in FIG. 1A.

The example embodiments are not, however, restricted to the system given as an example but a person skilled in the art may apply the solution to other communication systems provided with necessary properties.

The example of FIG. 1A shows a part of an exemplifying radio access network.

FIG. 1A shows user devices 100 and 102 configured to be in a wireless connection on one or more communication channels in a radio cell with an access node (AN) 104, such as an evolved Node B (abbreviated as eNB or eNodeB) or a next generation Node B (abbreviated as gNB or gNodeB), providing the radio cell. The physical link from a user device to an access node may be called uplink (UL) or reverse link, and the physical link from the access node to the user device may be called downlink (DL) or forward link. A user device may also communicate directly with another user device via sidelink (SL) communication. It should be appreciated that access nodes or their functionalities may be implemented by using any node, host, server or access point etc. entity suitable for such a usage.

A communication system may comprise more than one access node, in which case the access nodes may also be configured to communicate with one another over links, wired or wireless, designed for the purpose. These links may be used for signaling purposes and also for routing data from one access node to another. The access node may be a computing device configured to control the radio resources of communication system it is coupled to. The access node may also be referred to as a base station, a base transceiver station (BTS), an access point or any other type of interfacing device including a relay station capable of operating in a wireless environment. The access node may include or be coupled to transceivers. From the transceivers of the access node, a connection may be provided to an antenna unit that establishes bi-directional radio links to user devices. The antenna unit may comprise a plurality of antennas or antenna elements. The access node may further be connected to a core network 110 (CN or next generation core NGC). Depending on the deployed technology, the counterpart that the access node may be connected to on the CN side may be a serving gateway (S-GW, routing and forwarding user data packets), packet data network gateway (P-GW) for providing connectivity of user devices to external packet data networks, user plane function (UPF), mobility management entity (MME), or an access and mobility management function (AMF), etc.

The user device illustrates one type of an apparatus to which resources on the air interface may be allocated and assigned, and thus any feature described herein with a user device may be implemented with a corresponding apparatus, such as a relay node.

An example of such a relay node may be a layer 3 relay (self-backhauling relay) towards the access node. The self-backhauling relay node may also be called an integrated access and backhaul (IAB) node. The IAB node may comprise two logical parts: a mobile termination (MT) part, which takes care of the backhaul link(s) (i.e., link(s) between IAB node and a donor node, also known as a parent node) and a distributed unit (DU) part, which takes care of the access link(s), i.e., child link(s) between the IAB node and user device(s), and/or between the IAB node and other IAB nodes (multi-hop scenario).

Another example of such a relay node may be a layer 1 relay called a repeater. The repeater may amplify a signal received from an access node and forward it to a user device, and/or amplify a signal received from the user device and forward it to the access node.

The user device may also be called a subscriber unit, mobile station, remote terminal, access terminal, user terminal, terminal device, or user equipment (UE) just to mention but a few names or apparatuses. The user device may refer to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, multimedia device, reduced capability (RedCap) device, wireless sensor device, or any device integrated in a vehicle.

It should be appreciated that a user device may also be a nearly exclusive uplink-only device, of which an example may be a camera or video camera loading images or video clips to a network. A user device may also be a device having capability to operate in Internet of Things (IoT) network which is a scenario in which objects may be provided with the ability to transfer data over a network without requiring human-to-human or human-to-computer interaction. The user device may also utilize cloud. In some applications, a user device may comprise a small portable or wearable device with radio parts (such as a watch, earphones or eyeglasses) and the computation may be carried out in the cloud or in another user device. The user device (or in some example embodiments a layer 3 relay node) may be configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question may have inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1A) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications may support a wide range of use cases and related applications including video streaming, augmented reality, different ways of data sharing and various forms of machine type applications (such as (massive) machine-type communications (mMTC), including vehicular safety, different sensors and real-time control. 5G may have multiple radio interfaces, namely below 6 GHz, cmWave and mmWave, and also being integrable with existing legacy radio access technologies, such as the LTE. Integration with the LTE may be implemented, at least in the early phase, as a system, where macro coverage may be provided by the LTE, and 5G radio interface access may come from small cells by aggregation to the LTE. In other words, 5G may support both inter-RAT operability (such as LTE-5G) and inter-RI operability (inter-radio interface operability, such as below 6 GHz-cmWave-mmWave). One of the concepts considered to be used in 5G networks may be network slicing, in which multiple independent and dedicated virtual sub-networks (network instances) may be created within the substantially same infrastructure to run services that have different requirements on latency, reliability, throughput and mobility.

The current architecture in LTE networks may be fully distributed in the radio and fully centralized in the core network. The low latency applications and services in 5G may need to bring the content close to the radio which leads to local break out and multi-access edge computing (MEC). 5G may enable analytics and knowledge generation to occur at the source of the data. This approach may need leveraging resources that may not be continuously connected to a network such as laptops, smartphones, tablets and sensors. MEC may provide a distributed computing environment for application and service hosting. It may also have the ability to store and process content in close proximity to cellular subscribers for faster response time. Edge computing may cover a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system may also be able to communicate with one or more other networks 113, such as a public switched telephone network or the Internet, or utilize services provided by them. The communication network may also be able to support the usage of cloud services, for example at least part of core network operations may be carried out as a cloud service (this is depicted in FIG. 1A by “cloud” 114). The communication system may also comprise a central control entity, or the like, providing facilities for networks of different operators to cooperate for example in spectrum sharing.

An access node may also be split into: a radio unit (RU) comprising a radio transceiver (TRX), i.e., a transmitter (Tx) and a receiver (Rx); one or more distributed units (DUs) 105 that may be used for the so-called Layer 1 (L1) processing and real-time Layer 2 (L2) processing; and a central unit (CU) 108 (also known as a centralized unit) that may be used for non-real-time L2 and Layer 3 (L3) processing. The CU 108 may be connected to the one or more DUs 105 for example via an F1 interface. Such a split may enable the centralization of CUs relative to the cell sites and DUs, whereas DUs may be more distributed and may even remain at cell sites. The CU and DU together may also be referred to as baseband or a baseband unit (BBU). The CU and DU may also be comprised in a radio access point (RAP).

The CU 108 may be defined as a logical node hosting higher layer protocols, such as radio resource control (RRC), service data adaptation protocol (SDAP) and/or packet data convergence protocol (PDCP), of the access node. The DU 105 may be defined as a logical node hosting radio link control (RLC), medium access control (MAC) and/or physical (PHY) layers of the access node. The operation of the DU may be at least partly controlled by the CU. The CU may comprise a control plane (CU-CP), which may be defined as a logical node hosting the RRC and the control plane part of the PDCP protocol of the CU for the access node. The CU may further comprise a user plane (CU-UP), which may be defined as a logical node hosting the user plane part of the PDCP protocol and the SDAP protocol of the CU for the access node.

Cloud computing platforms may also be used to run the CU 108 and/or DU 105. The CU may run in a cloud computing platform, which may be referred to as a virtualized CU (vCU). In addition to the vCU, there may also be a virtualized DU (vDU) running in a cloud computing platform. Furthermore, there may also be a combination, where the DU may use so-called bare metal solutions, for example application-specific integrated circuit (ASIC) or customer-specific standard product (CSSP) system-on-a-chip (SoC) solutions. It should also be understood that the distribution of functions between the above-mentioned access node units, or different core network operations and access node operations, may differ.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head (RRH) or a radio unit (RU), or an access node comprising radio parts. It is also possible that node operations may be distributed among a plurality of servers, nodes or hosts. Application of cloudRAN architecture enables RAN real-time functions being carried out at the RAN side (e.g., in a DU 105) and non-real-time functions being carried out in a centralized manner (e.g., in a CU 108).

It should also be understood that the distribution of functions between core network operations and access node operations may differ from that of the LTE or even be non-existent. Some other technology advancements that may be used include big data and all-IP, which may change the way networks are being constructed and managed. 5G (or new radio, NR) networks may be designed to support multiple hierarchies, where MEC servers may be placed between the core and the access node. It should be appreciated that MEC may be applied in 4G networks as well.

5G may also utilize non-terrestrial communication, for example satellite communication, to enhance or complement the coverage of 5G service, for example by providing backhauling. Possible use cases may be providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano) satellites are deployed). A given satellite 106 in the mega-constellation may cover several satellite-enabled network entities that create on-ground cells. The on-ground cells may be created through an on-ground relay node or by an access node 104 located on-ground or in a satellite.

6G networks are expected to adopt flexible decentralized and/or distributed computing systems and architecture and ubiquitous computing, with local spectrum licensing, spectrum sharing, infrastructure sharing, and intelligent automated management underpinned by mobile edge computing, artificial intelligence, short-packet communication and blockchain technologies. Key features of 6G may include intelligent connected management and control functions, programmability, integrated sensing and communication, reduction of energy footprint, trustworthy infrastructure, scalability and affordability. In addition to these, 6G is also targeting new use cases covering the integration of localization and sensing capabilities into system definition to unifying user experience across physical and digital worlds.

It is obvious for a person skilled in the art that the depicted system is only an example of a part of a radio access system and in practice, the system may comprise a plurality of access nodes, the user device may have access to a plurality of radio cells and the system may also comprise other apparatuses, such as physical layer relay nodes or other network elements, etc. At least one of the access nodes may be a Home eNodeB or a Home gNodeB.

Additionally, in a geographical area of a radio communication system, a plurality of different kinds of radio cells as well as a plurality of radio cells may be provided. Radio cells may be macro cells (or umbrella cells) which may be large cells having a diameter of up to tens of kilometers, or smaller cells such as micro-, femto- or picocells. The access node(s) of FIG. 1A may provide any kind of these cells. A cellular radio system may be implemented as a multilayer network including several kinds of radio cells. In multilayer networks, one access node may provide one kind of a radio cell or radio cells, and thus a plurality of access nodes may be needed to provide such a network structure.

For fulfilling the need for improving the deployment and performance of communication systems, the concept of “plug-and-play” access nodes may be introduced. A network which may be able to use “plug-and-play” access nodes, may include, in addition to Home eNodeBs or Home gNodeBs, a Home Node B gateway, or HNB-GW (not shown in FIG. 1A). An HNB-GW, which may be installed within an operator's network, may aggregate traffic from a large number of Home eNodeBs or Home gNodeBs back to a core network.

There may be at least two types of uplink (UL) transmissions: dynamic grant (DG) and configured grant (CG) transmission. In DG transmission, the UE transmits a scheduling request (SR) to the access node (e.g., gNB) and receives an UL grant with a resource allocation. In CG transmission, the UE transmits UL data in the configured resources without the transmission of SR and UL grant, and thus the use of CG transmission may reduce latency compared to DG transmission. Currently, there are two types of CG configuration: type 1 CG and type 2 CG.

In type 1 CG, radio resource control (RRC) signaling indicates the full time-domain resource allocation including periodicity, offset, start symbol and length of physical uplink shared channel (PUSCH) and K repetitions over K slots/sub-slots (repK) without any signaling of physical layer, such as downlink control information (DCI). Herein the term “slot” refers to a time slot.

In type 2 CG, periodicity and repK may be indicated via RRC signaling. The other time-domain-related parameters may be indicated through the activation DCI.

In both DG and CG transmission, one PUSCH transmission instance may not be allowed to cross the slot boundary. Therefore, to avoid transmitting a long PUSCH across the slot boundary, the UE may transmit smaller PUSCHs in several repetitions scheduled by an UL grant or RRC in the consecutive available transmission occasions. The use of PUSCH repetitions for one transport block (TB) may also reduce latency and increase reliability of PUSCH transmission, where a UE may be configured to transmit a number of repetitions across consecutive transmission occasions without feedback.

In PUSCH repetition type A, a given slot may comprise one repetition and the time domain for the repetitions of a TB is the same in those slots.

In PUSCH repetition type B, the repetitions may be carried out in consecutive mini-slots, so that one slot may comprise more than one repetition of a TB. The repetitions may be segmented into smaller repetitions due to the slot boundary, downlink (DL) symbols and the symbols in an invalid pattern.

The network (for example the network illustrated in FIG. 1A) may support utilizing multiple transmission-reception points (TRPs). This may be referred to as multiple transmission-reception point (M-TRP) operation. M-TRP operation may support, for example, two or more TRPs. Thus, for example, the UE 100 may receive data and/or transmit data via a plurality of TRPs. The different TRPs may be controlled by, for example, the access node 104, such as a gNB. In other words, the TRPs may be associated with the same cell, which may be referred to as intra-cell TRP operation.

An example of such a system is illustrated in FIG. 1B, which may be understood to depict the system of FIG. 1A, but with greater accuracy with respect to the M-TRP scenario. In M-TRP operation, a given TRP may be identified by a TRP identifier (ID). Alternatively, the M-TRP operation may be implemented in such a manner that, instead of explicitly indicating the TRP ID, control resource sets (CORESETs) may be associated to specific TRPs using a CORESETPoolIndex value (e.g., a value of 0 or 1). CORESETs within a physical downlink control channel (PDCCH) configuration that have the same CORESETPoolIndex may be assumed by the UE to be configured to be provided from the same (set of) TRP(s).

Referring to FIG. 1B, two TRPs 104-1, 104-2 are shown. The UE 100 may transmit a first uplink transmission to a first TRP 104-1 (e.g., the TRP associated with CORESETPoolIndex 0) via a first antenna panel 100-1 of the UE 100, and the UE 100 may transmit a second uplink transmission to a second TRP 104-2 (e.g., the TRP associated with CORESETPoolIndex 1) via a second antenna panel 100-2 of the UE 100. The first uplink transmission and the second uplink transmission may be transmitted simultaneously, i.e., they may overlap at least partially in time. Alternatively, the first uplink transmission and the second uplink transmission may not be transmitted simultaneously, i.e., they may be transmitted one at a time.

In other words, the UE 100 may transmit the first uplink transmission and the second uplink transmission from different antenna panels of the UE. A given UE antenna panel may be identified by an index of a corresponding UE capability value set or by an antenna panel identifier (ID). Alternatively, or additionally, a given UE antenna panel may be identified by or associated with at least one reference signal (e.g., DL reference signal resource, such as non-zero-power channel state information reference signal, NZP-CSI-RS, or synchronization signal block, SSB), or transmission configuration indicator (TCI) state (e.g., DL TCI state or UL TCI state or joint DL and UL TCI state) or by an UL beam or UL reference signal.

Herein M-TRP operation may refer to single downlink control information (S-DCI) or multiple downlink control information (M-DCI) operation.

In S-DCI operation, one serving TRP may schedule the UL transmissions from the UE to multiple TRPs, and/or the DL transmissions from the multiple TRPs to the UE. The different CORESETs may or may not be grouped, i.e., the same CORESETpoolindex value may be configured or assumed for all the CORESETs; alternatively, no CORESETPoolIndex may be configured in this case. When configured with more than one value of CORESETPoolIndex (for example two sets of CORESETs may be configured in M-DCI operation), the UE may be expected to monitor downlink control information (DCI) transmissions simultaneously from CORESETs associated with different CORESETPoolIndex values. Currently, up to two values (k=0, 1) may be configured.

In M-DCI operation, each of the TRPs may operate independently, so that a given TRP schedules the UL transmissions from the UE to itself, and/or the DL transmissions from itself to the UE. The CORESETPoolIndex value may be used to group CORESETs under separate groups. In other words, when CORESETs share the same group ID or CORESETPoolindex value, they may be considered to be in the same group.

NR Release 17 supports S-DCI for time-division multiplexing (TDM) M-TRP PUSCH repetition and antenna panel selection. NR Release 17 was specified to enhance reliability of uplink transmission in the context of the M-TRP scenario. Based on the NR Release 17 capability value set index reporting, the network may be aware of the UE antenna panel (including information on the number of UL sounding reference signal, SRS, antenna ports) specific transmission capability of UL SRS codebook-based transmission into a certain spatial UL direction.

Based on this information, the network can trigger transmission of two different UL SRS resource sets with the usage of the codebook to obtain TRP-specific transmit precoder matrix indicator (TPMI) hypotheses (i.e., determine precoder index and rank selection) antenna-panel-specifically for PUSCH transmissions. These two different UL SRS resource sets may be configured with two different DL transmission configuration indicator (TCI) states, or two joint DL and UL TCI states, or two separate UL TCI states associated as the spatial source.

NR Release 17 introduced a unified TCI framework. The unified TCI framework means that TCI states, which have previously been used to provide quasi-co-location (QCL) assumptions for the reception of DL signals and channels, may also be used to provide spatial sources for the transmission of UL signals and channels. Furthermore, the unified TCI framework defines the concept of “indicated TCI state”. The indicated TCI state may be a joint DL and UL TCI state, or a separate DL TCI state and a separate UL TCI state. The indicated TCI state provides a QCL source for the set of DL signals and channels, and a spatial source for the set of UL signals and channels.

Based on the obtained TRP-specific TPMI and SRS resource indicator (SRI) information, the network may trigger non-simultaneous TRP-specific Rel-17 PUSCH transmission by indicating via DCI: a codepoint for a single SRS resource set indicator, in which 2-bits, and thereby 4 values, may be reserved, when two SRS resource sets are configured with usage of codebook or non-codebook, and otherwise 0-bit. The first value out of the four possible values of the DCI codepoint may be used to indicate which of the two SRIs, the first or the second, is used to enable dynamic switching between a single TRP (e.g., TRP1 or TRP2) PUSCH transmission in TDM manner, and the other remaining two bits may be used to enable M-TRP PUSCH transmission between TRP1 and TRP2 in TDM manner with repetition. Further, either cyclical or sequential mapping may be configured via RRC for mapping two SRIs to PUSCH repetitions.

Moreover, for codebook-based transmission, the DCI may comprise two separate codepoint fields for SRIs, and two precoding information and number of transmission layers fields. It is worth noting that the first field indicates the number of transmission layers, whereas the second field does not. For non-codebook-based transmission, the DCI may comprise two SRI codepoint fields, where the first one indicates the transmission layers and the second one does not. Based on the received S-DCI, the UE may then transmit the PUSCH transmission using the multiple antenna panels (one panel at a time in NR Release 17).

The NR Release 17 specification enables a UE to be configured with either codebook-based or non-codebook-based PUSCH transmission. In other words, based on this configuration, the UE may assume that, upon reception of DCI with or without uplink grant, SRS resource indicators and precoding information are associated with either codebook-based or non-codebook-based PUSCH transmission.

In NR Release 18, there is an objective to identify and specify enhancements for uplink MIMO. Enhancements on downlink MIMO that facilitate the use of large antenna array, for frequency range one (FR1) and for frequency range two (FR2), may also need to be introduced to fulfil the request for evolution of NR deployments.

A higher peak data rate for UL may be beneficial, for example, in short-range applications, such as home entertainment, video surveillance/monitoring in industrial/healthcare/safety, IAB, and other applications where the UE power and/or form-factor may not be as stringent as with legacy handheld devices. UL transmission with more than four transmit antenna ports may be useful in bridging the gap between DL and UL spectral efficiency, in both FR1 and FR2. Hence, there may be a need to provide methods and/or signalling solutions to overcome this issue for NR Release 18 and beyond.

One of the objectives of NR Release 18 is to define how to provide specification support for simultaneous UL transmission across two panels (STx2P).

In comparison to the S-DCI based TDM repetition scheme in NR Release 17, NR Release 18 will specify support for both S-DCI and M-DCI based simultaneous uplink multi-panel PUSCH schemes with space-division multiplexing (SDM) and single frequency network (SFN), with a target to enhance throughput and reliability with reduced latency.

In the SDM-based scheme, different layers or demodulation reference signal (DMRS) ports of one PUSCH are separately precoded and transmitted from different UE antenna panels simultaneously.

In the SFN-based transmission scheme, all of the same layers or DMRS ports of one PUSCH are transmitted from two different UE antenna panels simultaneously.

The NR Release 17 specifications do not provide support for S-DCI or M-DCI based simultaneous UL PUSCH transmission with multiple antenna panels. For S-DCI, the network may be assumed to have a centralized scheduler with an ideal backhaul between multiple TRPs, whereas for M-DCI a distributed scheduler with non-ideal backhaul may be assumed.

For NR Release 18 M-DCI based simultaneous multi-panel DG PUSCH+DG PUSCH transmissions within the same component carrier (CC), the UE may assume that different PUSCH transmissions are associated with different CORESETPoolIndex values, which can be determined implicitly from a CORESET associated with a triggering DCI configuration.

For CG-PUSCH, the association with CORESETPoolIndex value is not yet agreed. However, for type 2 CG, the association is likely to be similar as with DG-PUSCH, i.e., based on activation DCI. For type 1 CG, the association is likely to follow higher layer configuration for a given CG configuration.

For NR Release 18, there is an agreement to support simultaneous transmission across multiple panels (STxMP) PUSCH+PUSCH transmission in a multi-DCI based system. Two independent PUSCHs associated with different TRPs may be transmitted by a UE simultaneously in the same active bandwidth part (BWP). The total number of layers of these two PUSCHs may be up to 4, for example.

However, currently it remains unclear for M-DCI based simultaneous multi-panel transmission whether it is possible and how to apply different DMRS configurations for overlapping (simultaneous) PUSCH transmissions. Therefore, there is a challenge in how to enable, in the M-DCI scenario, the use of same or different DMRS configurations with overlapping PUSCH transmissions.

According to the NR Release 17 specifications, the UE may be configured with PUSCH parameters (i.e., PUSCH-Config) for a specific BWP which are common within a cell, including also uplink DMRS parameters (i.e., DMRS-UplinkConfig). Therefore, for M-DCI based simultaneous multi-panel PUSCH transmission, a single DMRS type (i.e., type-1 or type-2) may be semi-statically configured and defined as valid for all PUSCH transmissions within a serving cell. For M-DCI, due to independent scheduling decisions of uplink transmissions among TRPs, different DG-PUSCH transmissions associated with different TRPs may be fully or partially overlapping in time, and fully overlapping, partially overlapping, or not overlapping in frequency domain. When TRPs are scheduling PUSCH transmissions via M-DCI, antenna ports of DMRS for PUSCH may be independently indicated with a codepoint field associated with the antenna ports, where the indicated DMRS antenna ports may be the same or different.

Since the PUSCH-Config and corresponding DMRS-RS-UplinkConfig may be valid for all PUSCH transmissions with different TRPs in the serving cell, where the DMRS-RS-UplinkConfig may have the same scrambling IDs (e.g., scramblingID0, scramblingID1), the different TRPs may not be able to perform DMRS channel estimation for each TRP-specific PUSCH transmission. In other words, the DMRS antenna ports indicated by different TRPs cannot currently be distinguished from each other (e.g., when the UE is scheduled with simultaneous multi-panel PUSCH transmissions, where the same DMRS antenna port combination is indicated by both of the TRPs).

A similar problem may arise when the UE performs simultaneous multi-panel transmission with the following combinations: DG-PUSCH+CG-PUSCH or CG-PUSCH+CG-PUSCH. DG-PUSCH refers to dynamically granted (e.g., by gNB) PUSCH transmission and CG-PUSCH refers to the configured grant for PUSCH transmission (e.g., a periodical UL grant available to the UE without the need for the UE to explicitly request resources for each transmission).

As discussed above, the current specifications do not provide a solution to distinguish different UL DMRS antenna ports for simultaneous DG-PUSCH+DG-PUSCH or DG-PUSCH+CG-PUSCH or CG-PUSCH+CG-PUSCH transmissions to different TRPs. As result of this, the network may not be able to properly perform DMRS channel estimation associated with TRP-specific PUSCH transmissions. Furthermore, it may not be feasible for the network to coordinate the CG/DG resource allocations between TRPs for each UE, and thus a more efficient solution may be needed.

Some example embodiments relate to NR physical layer design for MIMO enhancements in NR Release 18 and beyond. Some example embodiments may address the above problem by providing an explicit or implicit indication mechanism to initialize UL DMRS sequence for M-DCI based simultaneous multi-panel PUSCH transmission.

Some example embodiments enable the network to initialize different UL DMRS antenna ports TRP-specifically for example for simultaneous DG-PUSCH+DG-PUSCH, or DG-PUSCH+CG-PUSCH, or CG-PUSCH+CG-PUSCH transmissions. As result of this, the network is able to distinguish different DMRS antenna ports TRP-specifically, and to perform DMRS channel estimation associated with TRP-specific PUSCH transmission.

In the context of M-DCI, the simultaneous multi-panel transmission means that a UE may transmit PUSCH simultaneously to at least two different TRPs, but the PUSCH transmissions may be different. For example, one of the PUSCH transmissions may have two layers (corresponding to two DMRS antenna ports), and the other PUSCH transmission may have one layer (corresponding to one DMRS antenna port). Herein the term “layer” may refer to a MIMO layer.

However, a common PUSCH configuration may be used for all the TRPs in a cell. By using TRP-specific DMRS sequence initialization offset values, a given DMRS sequence (associated with an uplink transmission to a particular TRP), may be initialized in a TRP-specific manner leading to a TPR-specific DMRS sequence (i.e., TRP-specific pseudo-random sequence) to be mapped on physical transmission resource element patterns of DMRS. This enables to distinguish the DMRS sequences for the different TRPs.

For example, when a first TRP schedules an uplink transmission to the first TRP from a first antenna panel of the UE, and a second TRP schedules an uplink transmission to the second TRP from a second antenna panel of the UE, then the DMRS sequence initialization means that the DMRS sequence will have a TRP-specific initialization. With the TRP-specific initialization, the DMRS sequence will also be generated in a TRP-specific manner. This way, the output of the TRP-specific DMRS sequence initialization may be a first DMRS sequence for the first TRP, and a second DMRS sequence for the second TRP.

Even if the uplink transmissions to the first TRP and the second TRP have the same resource allocation/configuration (e.g., resource element pattern structure), and the UE transmits the uplink transmissions simultaneously, then the TRP-specific DMRS sequences make the uplink transmissions to be separable in sequence domain. Knowing the TRP-specific DMRS sequence helps a given TRP to determine TRP-specific DMRS channel estimates for a TRP-specific PUSCH transmission.

As a result of TRP-specific DMRS channel estimations, the TRP can demodulate the PUSCH layers transmitted toward that specific TRP, even though the simultaneous uplink PUSCH transmissions to different TRPs may interfere with each other. Thus, when a given TRP knows the reference signal specific to that TRP, the TRP can estimate the interference for example by estimating firstly DMRS channel estimates by using the known DMRS sequence. After this, the TRP can regenerate the targeted TRP-specific DMRS transmission by using the estimated DMRS channel estimates and the known DRMS sequence as well as corresponding DMRS RE-pattern. Then, the TRP may subtract the regenerated TRP-specific DMRS transmission from the received signal to obtain the residual received interference, and then calculating the interference covariance matrix for the residual received interference signal. The interference covariance matrix would then correspond to the interference which may be used with an advanced receiver, such as interference rejection combiner (IRC) minimum mean square error (MMSE), or any linear or non-linear detector for PUSCH demodulation.

Alternatively, when the TRP has awareness of the DMRS sequence and corresponding RE-pattern of the interfering PUSCH transmission, the TRP may estimate explicitly the interference covariance matrix based on computed DMRS channel estimations of the interfering PUSCH transmission to another TRP and the targeted PUSCH transmission. Then, this interference covariance matrix may be used with an advanced receiver for the demodulation of the targeted PUSCH transmission.

Some example embodiments are described below using principles and terminology of 5G technology without limiting the example embodiments to 5G communication systems, however.

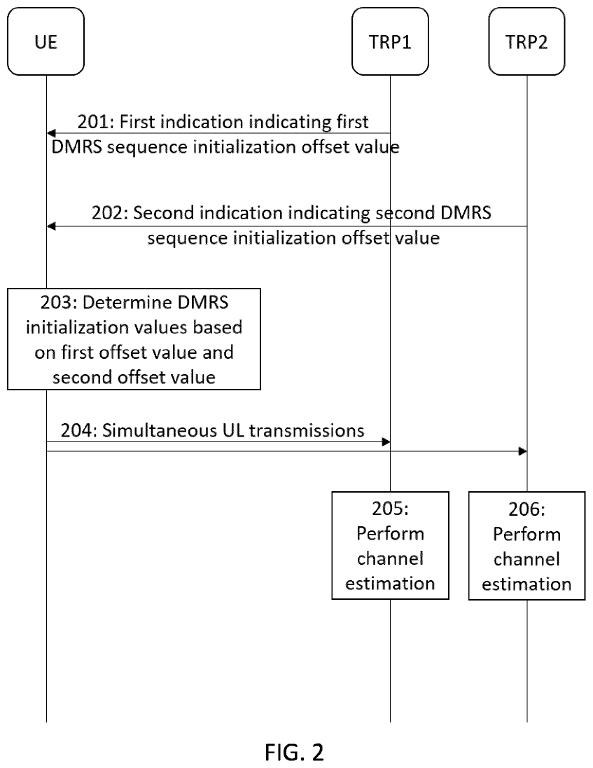

FIG. 2 illustrates a signaling diagram according to an example embodiment for the explicit indication mechanism. Although two TRPs are shown in FIG. 2, it should be noted that the number of TRPs may also be more than two. In other words, there may be two or more TRPs. In addition, the signaling procedure illustrated in FIG. 2 may be extended and applied according to the actual number of TRPs. Herein the terms TRP and gNB may be used interchangeably.

In this example embodiment, a user device is explicitly indicated with TRP-specific DMRS sequence initialization offset values (denoted as β), for example, for M-DCI based simultaneous multi-panel PUSCH transmissions (e.g., DG-PUSCH or CG-PUSCH transmissions).

For example, for DG-PUSCH or CG-PUSCH (both type 1 and type 2), a specific DMRS sequence initialization offset value, β, (that may be TRP-specific) may be explicitly indicated via RRC signaling.

Alternatively, the β value may be part of the configuration information for example for CG-PUSCH. For example, one of DCI formats (e.g., DCI format 0_1 or new DCI format) may have a new codepoint field for DMRS initialization offset, and upon the reception of DCI format 0_1, the user device may determine the DMRS sequence initialization value associated with TRP-specific PUSCH transmission by using the DCI-indicated DMRS sequence initialization offset value in DMRS sequence initialization. If the DMRS sequence initialization offset value is not included in the triggering DCI, the user device may use the RRC configured (TRP-specific) DMRS initialization offset.

Alternatively, for DG-PUSCH or CG-PUSCH, MAC CE may be used to dynamically indicate TRP-specific DMRS sequence initialization offset values for DMRS sequence initialization. For example, MAC CE may be used to refer to a specific CG-PUSCH configuration index and provide the applied β value that is associated with the CG-PUSCH.

Referring to FIG. 2, in block 201, a first TRP transmits a first indication to a user device, wherein the first indication indicates a first demodulation reference signal (DMRS) sequence initialization offset value for the first TRP. The first TRP may also be referred to as a first network node herein.

For example, the first indication may be transmitted via first radio resource control (RRC) signaling, or first downlink control information (DCI), or a first medium access control (MAC) control element (CE).

In case the first indication is transmitted via the first RRC signaling, the first DMRS sequence initialization offset value may be provided, for example, in the configured grant configuration (e.g., in the configuredGrantConfig information element).

In block 202, a second TRP (which is different to the first TRP) transmits a second indication to the user device, wherein the second indication indicates a second DMRS sequence initialization offset value for the second TRP. The second TRP may also be referred to as a second network node herein.

For example, the second indication may be transmitted via second RRC signaling, or second DCI, or a second MAC CE.

In case the second indication is transmitted via the second RRC signaling, the second DMRS sequence initialization offset value may be provided, for example, in the configured grant configuration (e.g., in the configuredGrantConfig information element).

The user device may correspond to the UE 100 of FIG. 1A or FIG. 1B. The first TRP may correspond to the TRP1 104-1 of FIG. 1B. The second TRP may correspond to the TRP2 104-2 of FIG. 1B. The first TRP and the second TRP may be controlled by the same access node (e.g., gNB), for example by the access node 104 of FIG. 1A or FIG. 1B.

Herein the terms “first TRP” and “second TRP” are used to distinguish the TRPs, and they do not necessarily mean specific identifiers of the TRPs.

The terms “first indication” and “second indication” are used to distinguish the indications, and they do not necessarily mean a specific order of the indications.

In block 203, the user device determines a first DMRS sequence initialization value based on the first DMRS sequence initialization offset value, and a second DMRS sequence initialization value based on the second DMRS sequence initialization offset value. In other words, the first DMRS sequence initialization offset value may be used to initialize the generation of a first DMRS sequence, and the second DMRS sequence initialization offset value may be used to initialize the generation of a second DMRS sequence different to the first DMRS sequence.

For example, for DG-PUSCH and CG-PUSCH (both type 1 and type 2), a TRP-specific DMRS initialization value (cᵢₙᵢₜ) may be determined based on a TRP-specific DMRS sequence initialization offset value (β) as follows:

$${c}_{init} = ( {2}^{17} ( {N}_{symb}^{slot} {n}_{s , f}^{μ} + l + 1 ) ( 2 {N}_{ID}^{{\overline{n}}_{SCID}^{\overline{λ}}} + 1 ) + {2}^{17} ⌊ \frac{\overline{λ}}{2} ⌋ + 2 {N}_{ID}^{{\overline{n}}_{SCID}^{\overline{λ}}} + {\overline{n}}_{SCID}^{\overline{λ}} + β ) mod {2}^{31}$$

where

$${N}_{symb}^{slot}$$

is the number of symbols in a slot,

$${n}_{s , f}^{μ}$$

is the slot number within a frame, l is the orthogonal frequency-division multiplexing (OFDM) symbol number within the slot,

$${N}_{ID}^{0} and {N}_{ID}^{1}$$

are higher-layer parameters scramblingID0 and scramblingID1,

$${\overline{n}}_{SCID}^{\overline{λ}} = {n}_{SCID} ,$$

λ̅=λ, when λ=0 or λ=2, and

$${\overline{n}}_{SCID}^{\overline{λ}} = 1 - {n}_{SCID}$$

when λ=1, where λ denotes the code-division multiplexing (CDM) group, and where n_{SCID}∈{0,1}.

In block 204, the user device transmits two simultaneous uplink transmissions, wherein the first uplink transmission is transmitted with the first DMRS sequence to the first TRP, and the second uplink transmission is transmitted with the second DMRS sequence to the second TRP. In other words, the user device performs, based on the first DMRS sequence initialization offset value, the first uplink transmission to the first TRP. Additionally, the user device performs, based on the second DMRS sequence initialization offset value, the second uplink transmission to the second TRP, wherein the first uplink transmission and the second uplink transmission may overlap at least partially in time and/or overlap at least partially in frequency.

The first uplink transmission may be performed based on a first TCI state, and the second uplink transmission may be performed based on a second TCI state. A given TCI state may include a DL/UL reference signal resource based on which the user device may determine the uplink beam or antenna panel used for a given UL transmission. For example, the first uplink transmission may be performed via a first antenna panel of the user device, and the second uplink transmission may be performed via a second antenna panel of the user device.

The first uplink transmission may comprise, for example, a first dynamic grant physical uplink shared channel (DG-PUSCH) transmission, or a first configured grant physical uplink shared channel (CG-PUSCH) transmission (type 1 or type 2).

The second uplink transmission may comprise, for example, a second DG-PUSCH transmission or a second CG-PUSCH transmission (type 1 or type 2).

In block 205, the first TRP performs channel estimation for the first uplink transmission based on the first DMRS sequence initialization offset value.

In block 206, the second TRP performs channel estimation for the second uplink transmission based on the second DMRS sequence initialization offset value.

The DMRS sequence initialization information (e.g., the DMRS sequence initialization offset values) may or may not be shared between the TRPs. In case the DMRS sequence initialization information is not shared between the TRPs, since each M-DCI associated with each TRP schedules TRP-specific PUSCH transmission, it is not necessary for a given TRP to know the DMRS initialization value associated with the PUSCH transmission to other TRPs. It is sufficient that the DMRS sequence associated with a given PUSCH transmission to a specific TRP differs from other PUSCH transmission(s) targeted to other TRP(s). For M-DCI, it may be assumed that different TRPs schedule independently their own TRP-specific PUSCH transmission.

In case the DMRS sequence initialization information is shared between the TRPs, for example in case one TRP would like to also demodulate the PUSCH transmission associated with another TRP, the DMRS initialization value may be exchanged between the TRPs via the backhaul network with corresponding signaling.

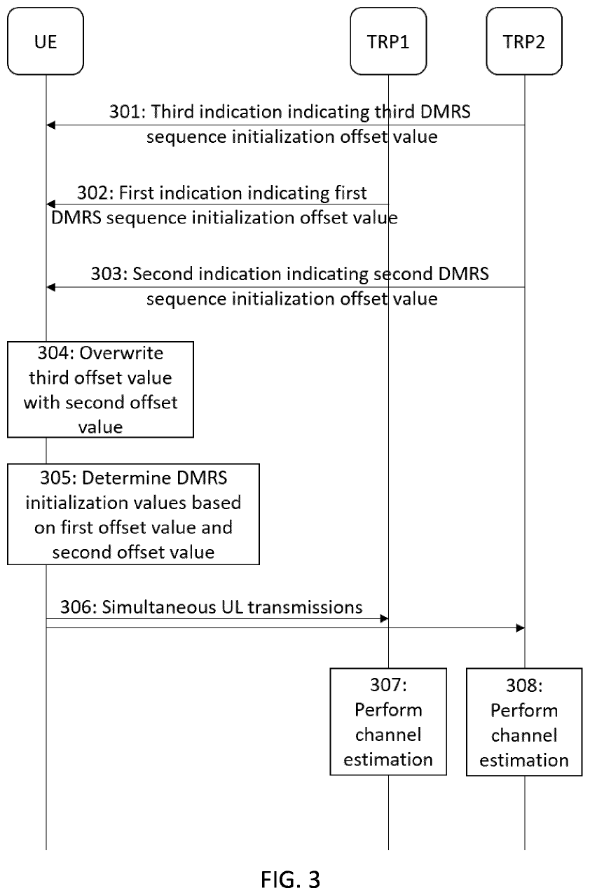

FIG. 3 illustrates a signaling diagram according to another example embodiment for the explicit indication mechanism. Although two TRPs are shown in FIG. 3, it should be noted that the number of TRPs may also be more than two. In other words, there may be two or more TRPs. In addition, the signaling procedure illustrated in FIG. 3 may be extended and applied according to the actual number of TRPs. Herein the terms TRP and gNB may be used interchangeably.

In this example embodiment, for example for M-DCI based DG-PUSCH or CG-PUSCH type 2, the DMRS sequence initialization offset value (β) may be dynamically indicated for example via DCI (e.g., as a new codepoint field or by reusing an existing codepoint field) or MAC CE to overwrite the RRC configured (TRP-specific) DMRS initialization offset value. The β value may be TRP-specific (e.g., based on CORESETPoolIndex value).

Referring to FIG. 3, in block 301 a second TRP transmits a third indication to a user device, wherein the third indication indicates a third demodulation reference signal (DMRS) sequence initialization offset value for the the second TRP (i.e., for the TRP which transmitted the third indication).

For example, the third indication may be transmitted via third radio resource control (RRC) signaling, or third downlink control information (DCI), or a third medium access control (MAC) control element (CE).

In case the third indication is transmitted via the third RRC signaling, the third DMRS sequence initialization offset value may be provided, for example, in the configured grant configuration (e.g., in the configuredGrantConfig information element).

In block 302, the first TRP transmits a first indication to the user device, wherein the first indication indicates a first DMRS sequence initialization offset value for the first TRP. The first TRP may also be referred to as a first network node herein.

For example, the first indication may be transmitted via first RRC signaling, or first DCI, or a first MAC CE.

In case the first indication is transmitted via the first RRC signaling, the first DMRS sequence initialization offset value may be provided, for example, in the configured grant configuration (e.g., in the configuredGrantConfig information element).

In block 303, the second TRP transmits a second indication to the user device, wherein the second indication indicates a second DMRS sequence initialization offset value for the second TRP. The second TRP may also be referred to as a second network node herein.

For example, the second indication may be transmitted via second RRC signaling, or second DCI, or a second MAC CE.

In case the second indication is transmitted via the second RRC signaling, the second DMRS sequence initialization offset value may be provided, for example, in the configured grant configuration (e.g., in the configuredGrantConfig information element).

Additionally, a fourth indication may be transmitted from the TRP1 (not shown in FIG. 3) before transmission of the first indication. Alternatively, the third indication may be transmitted from not the TRP2 but the TRP1 at block 301.

The user device may correspond to the UE 100 of FIG. 1A or FIG. 1B. The first TRP may correspond to the TRP1 104-1 of FIG. 1B. The second TRP may correspond to the TRP2 104-2 of FIG. 1B. The first TRP and the second TRP may be controlled by the same access node (e.g., gNB), for example by the access node 104 of FIG. 1A or FIG. 1B.

Herein the terms “first TRP” and “second TRP” are used to distinguish the TRPs, and they do not necessarily mean specific identifiers of the TRPs.

The terms “first indication”, “second indication”, “third indication”, and “fourth indication” are used to distinguish the indications, and they do not necessarily mean a specific order of the indications.

In block 304, the user device overwrites the third DMRS sequence initialization offset value (and/or the fourth DMRS sequency initialization offset value) with the first DMRS sequence initialization offset value and/or the second DMRS sequence initialization offset value. In other words, the user device may ignore the third and/or fourth DMRS sequence initialization offset value when the substitute indication is received within a predetermined time.

For example, if the user device received the third indication from the first TRP via the third RRC signaling, and the user device subsequently receives the first indication from the first TRP via the first DCI or the first MAC CE, then the user device may overwrite the third DMRS sequence initialization offset value with the first DMRS sequence initialization offset value.

As another example, if the user device received the third indication from the second TRP via the third RRC signaling, and the user device subsequently receives the second indication from the second TRP via the second DCI or the second MAC CE, then the user device may overwrite the third DMRS sequence initialization offset value with the second DMRS sequence initialization offset value.

In block 305, the user device determines a first DMRS sequence initialization value based on the first DMRS sequence initialization offset value, and a second DMRS sequence initialization value based on the second DMRS sequence initialization offset value. In other words, the first DMRS sequence initialization offset value may be used to initialize the generation of a first DMRS sequence, and the second DMRS sequence initialization offset value may be used to initialize the generation of a second DMRS sequence different to the first DMRS sequence.

For example, for DG-PUSCH and CG-PUSCH (both type 1 and type 2), a TRP-specific DMRS initialization value (cᵢₙᵢₜ) may be determined based on a TRP-specific DMRS sequence initialization offset value (β) as follows:

$${c}_{init} = ( {2}^{17} ( {N}_{symb}^{slot} {n}_{s , f}^{μ} + l + 1 ) ( 2 {N}_{ID}^{{\overline{n}}_{SCID}^{\overline{λ}}} + 1 ) + {2}^{17} ⌊ \frac{\overline{λ}}{2} ⌋ + 2 {N}_{ID}^{{\overline{n}}_{SCID}^{\overline{λ}}} + {\overline{n}}_{SCID}^{\overline{λ}} + β ) mod {2}^{31}$$

where

$${N}_{symb}^{slot}$$

is the number of symbols in a slot,

$${n}_{s , f}^{μ}$$

is the slot number within a frame, l is the orthogonal frequency-division multiplexing (OFDM) symbol number within the slot,

$${N}_{ID}^{0} and {N}_{ID}^{1}$$

are higher-layer parameters scramblingID0 and scramblingID1,

$${\overline{n}}_{SCID}^{\overline{λ}} = {n}_{SCID} ,$$

λ̅=λ, when λ=0 or λ=2, and

$${\overline{n}}_{SCID}^{\overline{λ}} = 1 - {n}_{SCID}$$

when λ=1, where λ denotes the code-division multiplexing (CDM) group, and where n_{SCID}∈{0,1}.

In block 306, the user device transmits two simultaneous uplink transmissions, wherein the first uplink transmission is transmitted with the first DMRS sequence to the first TRP, and the second uplink transmission is transmitted with the second DMRS sequence to the second TRP. In other words, the user device performs, based on the first DMRS sequence initialization offset value, the first uplink transmission to the first TRP. Additionally, the user device performs, based on the second DMRS sequence initialization offset value, the second uplink transmission to the second TRP, wherein the first uplink transmission and the second uplink transmission may overlap at least partially in time and/or overlap at least partially in frequency.

The first uplink transmission may be performed based on a first TCI state, and the second uplink transmission may be performed based on a second TCI state. For example, the first uplink transmission may be performed via a first antenna panel of the user device, and the second uplink transmission may be performed via a second antenna panel of the user device.

The first uplink transmission may comprise, for example, a first dynamic grant physical uplink shared channel (DG-PUSCH) transmission, or a first configured grant physical uplink shared channel (CG-PUSCH) transmission (type 1 or type 2).

The second uplink transmission may comprise, for example, a second DG-PUSCH transmission or a second CG-PUSCH transmission (type 1 or type 2).

In block 307, the first TRP performs channel estimation for the first uplink transmission based on the first DMRS sequence initialization offset value.

In block 308, the second TRP performs channel estimation for the second uplink transmission based on the second DMRS sequence initialization offset value.

The DMRS sequence initialization information (e.g., the DMRS sequence initialization offset values) may or may not be shared between the TRPs. In case the DMRS sequence initialization information is not shared between the TRPs, since each M-DCI associated with each TRP schedules TRP-specific PUSCH transmission, it is not necessary for a given TRP to know the DMRS initialization value associated with the PUSCH transmission to other TRPs. It is sufficient that the DMRS sequence associated with a given PUSCH transmission to a specific TRP differs from other PUSCH transmission(s) targeted to other TRP(s). For M-DCI, it may be assumed that different TRPs schedule independently their own TRP-specific PUSCH transmission.

In case the DMRS sequence initialization information is shared between the TRPs, for example in case one TRP would like to also demodulate the PUSCH transmission associated with another TRP, the DMRS initialization value may be exchanged between the TRPs via the backhaul network with corresponding signaling.

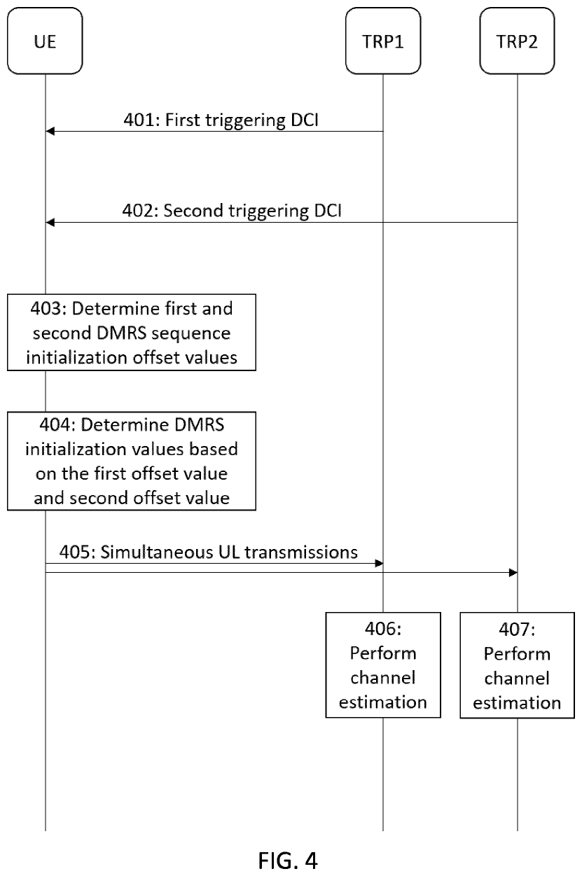

FIG. 4 illustrates a signaling diagram according to an example embodiment for the implicit indication mechanism. Although two TRPs are shown in FIG. 4, it should be noted that the number of TRPs may also be more than two. In other words, there may be two or more TRPs. In addition, the signaling procedure illustrated in FIG. 4 may be extended and applied according to the actual number of TRPs. Herein the terms TRP and gNB may be used interchangeably.

In this example embodiment, the user device implicitly determines TRP-specific DMRS sequence initialization offset values (denoted as β) for example for M-DCI based simultaneous multi-panel PUSCH transmission. For example, for CG-PUSCH type 2 and DG-PUSCH, the UE may determine a given DMRS sequence initialization offset value from the CORESETPoolIndex value associated with the CORESET of the triggering DCI.

Referring to FIG. 4, in block 401, a first TRP transmits, to a user device, first information, for example first DCI, for triggering simultaneous uplink transmissions from the user device. The first TRP may also be referred to as a first network node herein.

The first information may indicate at least one of: a first CORESETPoolIndex value, a first TCI state, or a first PUSCH configuration. For example, the user device may determine the first CORESETPoolIndex value from the CORESET associated with the triggering PDCCH (i.e., the first DCI). The first TCI state may also be referred to as a first indicated TCI state.

In block 402, a second TRP (which is different to the first TRP) transmits, to the user device, second information, for example second DCI, for triggering simultaneous uplink transmissions from the user device. The second TRP may also be referred to as a second network node herein.

The second information may indicate at least one of: a second CORESETPoolIndex value, a second TCI state, or a second PUSCH configuration. For example, the user device may determine the second CORESETPoolIndex value from the CORESET associated with the triggering PDCCH (i.e., the second DCI). The second TCI state may also be referred to as a second indicated TCI state.

The user device may correspond to the UE 100 of FIG. 1A or FIG. 1B. The first TRP may correspond to the TRP1 104-1 of FIG. 1B. The second TRP may correspond to the TRP2 104-2 of FIG. 1B. The first TRP and the second TRP may be controlled by the same access node (e.g., gNB), for example by the access node 104 of FIG. 1A or FIG. 1B.

Herein the terms “first TRP” and “second TRP” are used to distinguish the TRPs, and they do not necessarily mean specific identifiers of the TRPs.

The terms “first information” and “second information” are used to distinguish the information, and they do not necessarily mean a specific order of the information.

In block 403, the user device determines TRP-specific DMRS sequence initialization offset values.

The user device determines a first DMRS sequence initialization offset value for the first TRP, wherein the first DMRS sequence initialization offset value is determined based on at least one of: the first CORESETPoolIndex value related to the first DCI, the first indicated TCI state, or the first PUSCH configuration.

The user device determines a second DMRS sequence initialization offset value for the second TRP, wherein the second DMRS sequence initialization offset value is determined based on at least one of: the second CORESETPoolIndex value related to the second DCI, the second indicated TCI state, or the second PUSCH configuration.

For example, in case the DMRS sequence initialization offset values are determined based on the CORESETPoolIndex values, then the first DMRS sequence initialization offset value may be equal to the first CORESETPoolIndex value, and the second DMRS sequence initialization offset value may be equal to the second CORESETPoolIndex value. As a non-limiting example, upon reception of DCI 0_1 with CORESETPoolIndex value=1, the user device may use CORESETPoolIndex value=1 as the TRP-specific DMRS sequence initialization offset value, i.e., β=CORESETPoolIndex value. By using this value, the user device may determine TRP-specific DMRS sequence initialization for TRP-specific PUSCH transmission.

In some examples, there may be one or more values per CORESETPoolIndex. For example, CORESETPoolIndex value=1 may be associated with β values of β₁, β₂, βₙ, and CORESETPoolIndex value=0 may be associated with β values of βₙ₊₁, βₙ₊₂, βₙ₊ₘ. Any of these values may be dynamically or semi-statically indicated, or configured via RRC signaling.

In another example, the value of β may be fixed in the specification. For example, when more than one CORESETPoolndex values are configured for the user device, the specific β values may be used in association with the CORESETPoolIndex. That is, the first DMRS sequence initialization offset value may be equal to a first pre-defined DMRS sequence initialization offset value associated with the first CORESETPoolIndex value, and the second DMRS sequence initialization offset value may be equal to a second pre-defined DMRS sequence initialization offset value associated with the second CORESETPoolIndex value.

In another example, the user device may be configured or the user device may determine to use/apply at least one parameter value for the DMRS sequence initialization for an uplink transmission that is dependent on the CORESETPoolIndex value or is associated with the CORESETPoolIndex value, or dependent on whether the user device is configured with more than one CORESETPoolIndex value.

In another example, the β may be configured in an indicated TCI state specific manner, in which case the DMRS sequences would be beam-specific. For example, there may be a first indicated TCI state and a second indicated TCI state, in which case the first DMRS sequence initialization offset value may be determined based on the first indicated TCI state, and the second DMRS sequence initialization offset value may be determined based on the second indicated TCI state.

In another example, if the user device is configured with multiple PUSCH configurations, the value of β may be specific to a given PUSCH configuration. For example, the first DMRS sequence initialization offset value may be determined based on a first PUSCH configuration, and the second DMRS sequence initialization offset value may be determined based on a second PUSCH configuration.

In any of the above examples, the β may have an integer value space. The value may be positive or negative. In case the value is not configured by the network, the value of β=0 may be used if the β is used in addition (+β) in a formula, or β=1 may be used if the β is used as a multiplier.

In block 404, the user device determines a first DMRS sequence initialization value based on the first DMRS sequence initialization offset value, and a second DMRS sequence initialization value based on the second DMRS sequence initialization offset value. In other words, the first DMRS sequence initialization offset value may be used to initialize the generation of a first DMRS sequence, and the second DMRS sequence initialization offset value may be used to initialize the generation of a second DMRS sequence different to the first DMRS sequence.

For example, for DG-PUSCH and CG-PUSCH (both type 1 and type 2), a TRP-specific DMRS initialization value (cᵢₙᵢₜ) may be determined based on a TRP-specific DMRS sequence initialization offset value (β) as follows:

$${c}_{init} = ( {2}^{17} ( {N}_{symb}^{slot} {n}_{s , f}^{μ} + l + 1 ) ( 2 {N}_{ID}^{{\overline{n}}_{SCID}^{\overline{λ}}} + 1 ) + {2}^{17} ⌊ \frac{\overline{λ}}{2} ⌋ + 2 {N}_{ID}^{{\overline{n}}_{SCID}^{\overline{λ}}} + {\overline{n}}_{SCID}^{\overline{λ}} + β ) mod {2}^{31}$$

where

$${N}_{symb}^{slot}$$

is the number of symbols in a slot,

$${n}_{s , f}^{μ}$$

is the slot number within a frame, l is the orthogonal frequency-division multiplexing (OFDM) symbol number within the slot,

$${N}_{ID}^{0} and {N}_{ID}^{1}$$

are higher-layer parameters scramblingID0 and scramblingID1,

$${\overline{n}}_{SCID}^{\overline{λ}} = {n}_{SCID} ,$$

λ̅=λ, when λ=0 or λ=2, and

$${\overline{n}}_{SCID}^{\overline{λ}} = 1 - {n}_{SCID}$$

when λ=1, where λ denotes the code-division multiplexing (CDM) group, and where n_{SCID}∈{0,1}.

In block 405, the user device transmits two simultaneous uplink transmissions, wherein the first uplink transmission is transmitted with the first DMRS sequence to the first TRP, and the second uplink transmission is transmitted with the second DMRS sequence to the second TRP. In other words, the user device performs, based on the first DMRS sequence initialization offset value, the first uplink transmission to the first TRP. Additionally, the user device performs, based on the second DMRS sequence initialization offset value, the second uplink transmission to the second TRP, wherein the first uplink transmission and the second uplink transmission may overlap at least partially in time and/or overlap at least partially in frequency.

The first uplink transmission may be performed based on a first TCI state, and the second uplink transmission may be performed based on a second TCI state. For example, the first uplink transmission may be performed via a first antenna panel of the user device, and the second uplink transmission may be performed via a second antenna panel of the user device.

The first uplink transmission may comprise, for example, a first dynamic grant physical uplink shared channel (DG-PUSCH) transmission, or a first configured grant physical uplink shared channel (CG-PUSCH) transmission (type 1 or type 2).

The second uplink transmission may comprise, for example, a second DG-PUSCH transmission or a second CG-PUSCH transmission (type 1 or type 2).

In block 406, the first TRP performs channel estimation for the first uplink transmission based on the first DMRS sequence initialization offset value.

In block 407, the second TRP performs channel estimation for the second uplink transmission based on the second DMRS sequence initialization offset value.

The rule that indicates how to determine the TRP-specific DMRS sequence initialization offset values (as described in the above examples) may be configured to the user device by the network. For example, the rule may be indicated in the first information from the first TRP, or in the second information from the second TRP. Thus, the network (e.g., the first TRP and the second TRP) may also be aware of the rule used by the user device for determining the TRP-specific DMRS sequence initialization offset values, and the TRPs may determine the same TRP-specific value of β as determined by the user device.

The DMRS sequence initialization information (e.g., the DMRS sequence initialization offset values) may or may not be shared between the TRPs. In case the DMRS sequence initialization information is not shared between the TRPs, since each M-DCI associated with each TRP schedules TRP-specific PUSCH transmission, it is not necessary for a given TRP to know the DMRS initialization value associated with the PUSCH transmission to other TRPs. It is sufficient that the DMRS sequence associated with a given PUSCH transmission to a specific TRP differs from other PUSCH transmission(s) targeted to other TRP(s). For M-DCI, it may be assumed that different TRPs schedule independently their own TRP-specific PUSCH transmission.

In case the DMRS sequence initialization information is shared between the TRPs, for example in case one TRP would like to also demodulate the PUSCH transmission associated with another TRP, the DMRS initialization value may be exchanged between the TRPs via the backhaul network with corresponding signaling.

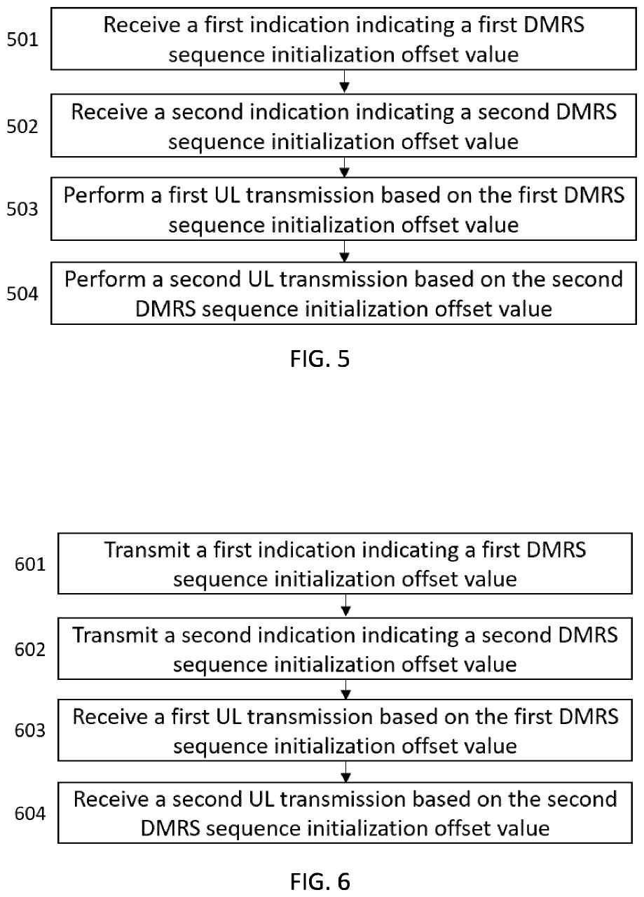

FIG. 5 illustrates a flow chart according to an example embodiment of a method performed by an apparatus. For example, the apparatus may be, or comprise, or be comprised in, a user device. The user device may also be called a subscriber unit, mobile station, remote terminal, access terminal, user terminal, terminal device, or user equipment (UE). The user device may correspond to the user device 100 of FIG. 1A or FIG. 1B.

Referring to FIG. 5, in block 501, a first indication indicating a first demodulation reference signal (DMRS) sequence initialization offset value for a first network node (e.g., a first TRP or gNB) is received.

In block 502, a second indication indicating a second DMRS sequence initialization offset value for a second network node (e.g., a second TRP or gNB) is received.

In block 503, based on the first DMRS sequence initialization offset value, a first uplink transmission to the first network node is performed.

In block 504, based on the second DMRS sequence initialization offset value, a second uplink transmission to the second network node is performed, wherein the first uplink transmission and the second uplink transmission overlap at least partially in time.

FIG. 6 illustrates a flow chart according to an example embodiment of a method performed by an apparatus. For example, the apparatus may be, or comprise, or be comprised in, a network node of a radio access network. The network node may correspond to the access node 104 of FIG. 1A or FIG. 1B.

Referring to FIG. 6, in block 601, a first indication indicating a first demodulation reference signal (DMRS) sequence initialization offset value is transmitted via a first network node (e.g., a first TRP or gNB).

In block 602, a second indication indicating a second DMRS sequence initialization offset value is transmitted via a second network node (e.g., a second TRP or gNB).

In block 603, a first uplink transmission based on the first DMRS sequence initialization offset value is received via the first network node.

In block 604, a second uplink transmission based on the second DMRS sequence initialization offset value is received via the second network node, wherein the first uplink transmission and the second uplink transmission overlap at least partially in time.

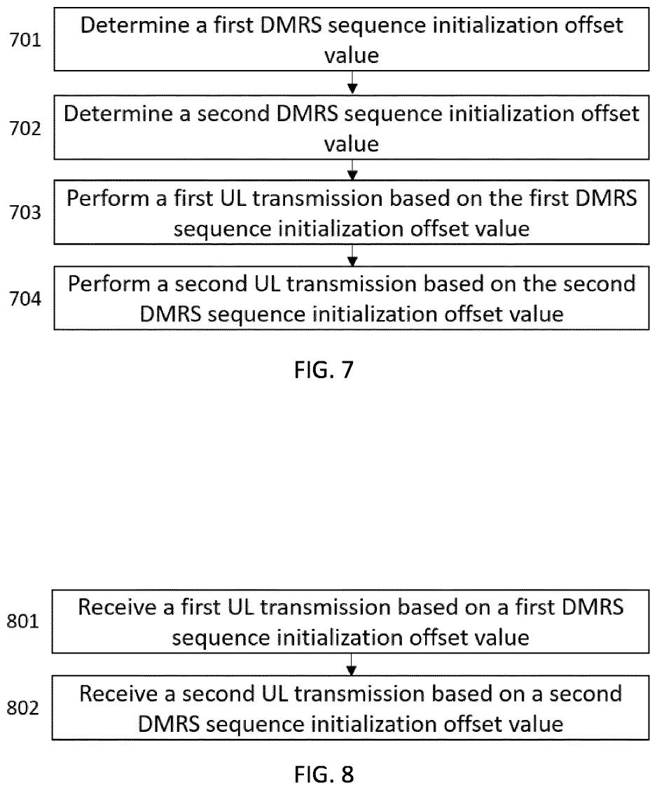

FIG. 7 illustrates a flow chart according to an example embodiment of a method performed by an apparatus. For example, the apparatus may be, or comprise, or be comprised in, a user device. The user device may also be called a subscriber unit, mobile station, remote terminal, access terminal, user terminal, terminal device, or user equipment (UE). The user device may correspond to the user device 100 of FIG. 1A or FIG. 1B.

Referring to FIG. 7, in block 701, a first demodulation reference signal (DMRS) sequence initialization offset value for a first network node (e.g., a first TRP or gNB) is determined, wherein the first DMRS sequence initialization offset value is determined based on at least one of: a first control resource set pool index (CORESETPoolIndex) value related to a first downlink control information (DCI), a first transmission configuration indicator (TCI) state, or a first physical uplink shared channel (PUSCH) configuration.

In block 702, a second DMRS sequence initialization offset value for a second network node (e.g., a second TRP or gNB) is determined, wherein the second DMRS sequence initialization offset value is determined based on at least one of: a second CORESETPoolIndex value related to a second DCI, a second TCI state, or a second PUSCH configuration.

In block 703, based on the first DMRS sequence initialization offset value, a first uplink transmission to the first network node is performed.

In block 704, based on the second DMRS sequence initialization offset value, a second uplink transmission to the second network node is performed, wherein the first uplink transmission and the second uplink transmission overlap at least partially in time.

FIG. 8 illustrates a flow chart according to an example embodiment of a method performed by an apparatus. For example, the apparatus may be, or comprise, or be comprised in, a network node of a radio access network. The network node may correspond to the access node 104 of FIG. 1A or FIG. 1B.

Referring to FIG. 8, in block 801, a first uplink transmission based on a first DMRS sequence initialization offset value is received from a user device via a first network node (e.g., a first TRP or gNB), wherein the first DMRS sequence initialization offset value is based on at least one of: a first control resource set pool index (CORESETPoolIndex) value related to a first downlink control information (DCI), a first transmission configuration indicator (TCI) state, or a first physical uplink shared channel (PUSCH) configuration.

In block 802, a second uplink transmission based on a second DMRS sequence initialization offset value is received from the user device via a second network node (e.g., a second TRP or gNB), wherein the second DMRS sequence initialization offset value is based on at least one of: a second CORESETPoolIndex value related to a second DCI, a second TCI state, or a second PUSCH configuration, and wherein the first uplink transmission and the second uplink transmission overlap at least partially in time

The blocks, related functions, and information exchanges (messages) described above by means of FIGS. 2-8 are in no absolute chronological order, and some of them may be performed simultaneously or in an order differing from the described one. Other functions can also be executed between them or within them, and other information may be sent, and/or other rules applied. Some of the blocks or part of the blocks or one or more pieces of information can also be left out or replaced by a corresponding block or part of the block or one or more pieces of information.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

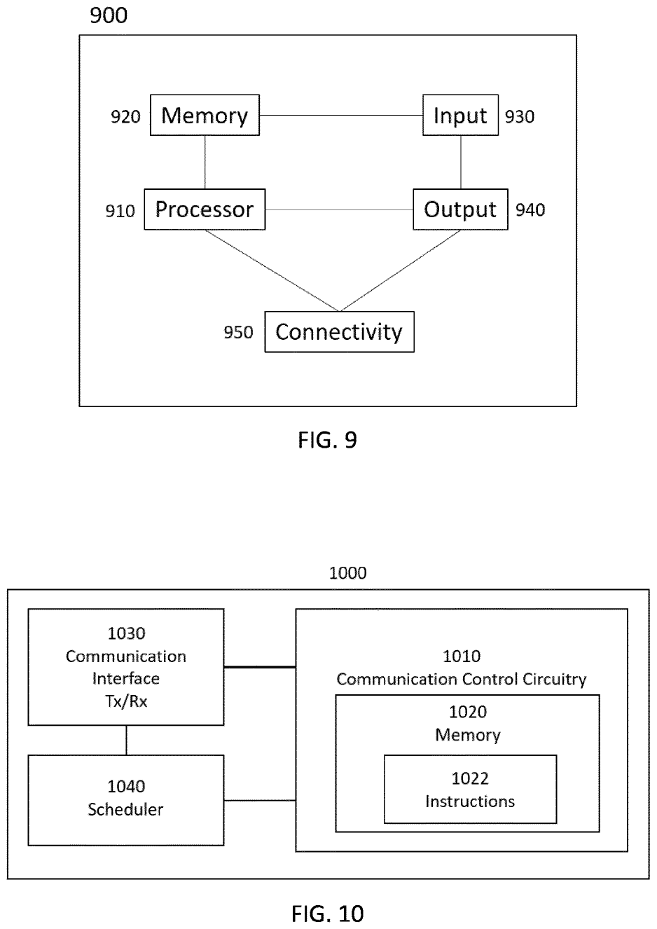

FIG. 9 illustrates an example of an apparatus 900 comprising means for performing one or more of the example embodiments described above. For example, the apparatus 900 may be an apparatus such as, or comprising, or comprised in, a user device. The user device may correspond to the user device 100 of FIG. 1A or FIG. 1B. The user device may also be called a subscriber unit, mobile station, remote terminal, access terminal, user terminal, terminal device, or user equipment (UE).

The apparatus 900 may comprise a circuitry or a chipset applicable for realizing one or more of the example embodiments described above. For example, the apparatus 900 may comprise at least one processor 910. The at least one processor 910 interprets instructions (e.g., computer program instructions) and processes data. The at least one processor 910 may comprise one or more programmable processors. The at least one processor 910 may comprise programmable hardware with embedded firmware and may, alternatively or additionally, comprise one or more application-specific integrated circuits (ASICs).

The at least one processor 910 is coupled to at least one memory 920. The at least one processor is configured to read and write data to and from the at least one memory 920. The at least one memory 920 may comprise one or more memory units. The memory units may be volatile or non-volatile. It is to be noted that there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The term “non-transitory,” as used herein, is a limitation of the medium itself (i.e., tangible, not a signal) as opposed to a limitation on data storage persistency (e.g., RAM vs. ROM). The at least one memory 920 stores computer readable instructions that are executed by the at least one processor 910 to perform one or more of the example embodiments described above. For example, non-volatile memory stores the computer readable instructions, and the at least one processor 910 executes the instructions using volatile memory for temporary storage of data and/or instructions. The computer readable instructions may refer to computer program code.

The computer readable instructions may have been pre-stored to the at least one memory 920 or, alternatively or additionally, they may be received, by the apparatus, via an electromagnetic carrier signal and/or may be copied from a physical entity such as a computer program product. Execution of the computer readable instructions by the at least one processor 910 causes the apparatus 900 to perform one or more of the example embodiments described above. That is, the at least one processor and the at least one memory storing the instructions may provide the means for providing or causing the performance of any of the methods and/or blocks described above.

In the context of this document, a “memory” or “computer-readable media” or “computer-readable medium” may be any non-transitory media or medium or means that can contain, store, communicate, propagate or transport the instructions for use by or in connection with an instruction execution system, apparatus, or device, such as a computer. The term “non-transitory,” as used herein, is a limitation of the medium itself (i.e., tangible, not a signal) as opposed to a limitation on data storage persistency (e.g., RAM vs. ROM).

The apparatus 900 may further comprise, or be connected to, an input unit 930. The input unit 930 may comprise one or more interfaces for receiving input. The one or more interfaces may comprise for example one or more temperature, motion and/or orientation sensors, one or more cameras, one or more accelerometers, one or more microphones, one or more buttons and/or one or more touch detection units. Further, the input unit 930 may comprise an interface to which external devices may connect to.

The apparatus 900 may also comprise an output unit 940. The output unit may comprise or be connected to one or more displays capable of rendering visual content, such as a light emitting diode (LED) display, a liquid crystal display (LCD) and/or a liquid crystal on silicon (LCoS) display. The output unit 940 may further comprise one or more audio outputs. The one or more audio outputs may be for example loudspeakers.

The apparatus 900 further comprises a connectivity unit 950. The connectivity unit 950 enables wireless connectivity to one or more external devices. The connectivity unit 950 comprises at least one transmitter and at least one receiver that may be integrated to the apparatus 900 or that the apparatus 900 may be connected to. The at least one transmitter comprises at least one transmission antenna, and the at least one receiver comprises at least one receiving antenna. The connectivity unit 950 may comprise an integrated circuit or a set of integrated circuits that provide the wireless communication capability for the apparatus 900. Alternatively, the wireless connectivity may be a hardwired application-specific integrated circuit (ASIC). The connectivity unit 950 may also provide means for performing at least some of the blocks of one or more example embodiments described above. The connectivity unit 950 may comprise one or more components, such as: power amplifier, digital front end (DFE), analog-to-digital converter (ADC), digital-to-analog converter (DAC), frequency converter, (de) modulator, and/or encoder/decoder circuitries, controlled by the corresponding controlling units.

It is to be noted that the apparatus 900 may further comprise various components not illustrated in FIG. 9. The various components may be hardware components and/or software components.

FIG. 10 illustrates an example of an apparatus 1000 comprising means for performing one or more of the example embodiments described above. For example, the apparatus 1000 may be an apparatus such as, or comprising, or comprised in, a network node of a radio access network. The network node may correspond to the access node 104 of FIG. 1A or FIG. 1B. The network node may also be referred to, for example, as a network element, a radio access network (RAN) node, a next generation radio access network (NG-RAN) node, a NodeB, an eNB, a gNB, a base transceiver station (BTS), a base station, an NR base station, a 5G base station, an access node, an access point (AP), a relay node, a repeater, an integrated access and backhaul (IAB) node, an IAB donor node, a distributed unit (DU), a central unit (CU), a baseband unit (BBU), a radio unit (RU), a radio head, a remote radio head (RRH), or a transmission-reception point (TRP).

The apparatus 1000 may comprise, for example, a circuitry or a chipset applicable for realizing one or more of the example embodiments described above. The apparatus 1000 may be an electronic device comprising one or more electronic circuitries. The apparatus 1000 may comprise a communication control circuitry 1010 such as at least one processor, and at least one memory 1020 storing instructions 1022 which, when executed by the at least one processor, cause the apparatus 1000 to carry out one or more of the example embodiments described above. Such instructions 1022 may, for example, include a computer program code (software), wherein the at least one memory and the computer program code (software) are configured, with the at least one processor, to cause the apparatus 1000 to carry out one or more of the example embodiments described above. The at least one processor and the at least one memory storing the instructions may provide the means for providing or causing the performance of any of the methods and/or blocks described above.

The processor is coupled to the memory 1020. The processor is configured to read and write data to and from the memory 1020. The memory 1020 may comprise one or more memory units. The memory units may be volatile or non-volatile. It is to be noted that there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The term “non-transitory,” as used herein, is a limitation of the medium itself (i.e., tangible, not a signal) as opposed to a limitation on data storage persistency (e.g., RAM vs. ROM). The memory 1020 stores computer readable instructions that are executed by the processor. For example, non-volatile memory stores the computer readable instructions and the processor executes the instructions using volatile memory for temporary storage of data and/or instructions.

The computer readable instructions may have been pre-stored to the memory 1020 or, alternatively or additionally, they may be received, by the apparatus, via an electromagnetic carrier signal and/or may be copied from a physical entity such as a computer program product. Execution of the computer readable instructions causes the apparatus 1000 to perform one or more of the functionalities described above.

The memory 1020 may be implemented using any suitable data storage technology, such as semiconductor-based memory devices, flash memory, magnetic memory devices and systems, optical memory devices and systems, fixed memory and/or removable memory. The memory may comprise a configuration database for storing configuration data. For example, the configuration database may store a current neighbour cell list, and, in some example embodiments, structures of the frames used in the detected neighbour cells.

The apparatus 1000 may further comprise a communication interface 1030 comprising hardware and/or software for realizing communication connectivity according to one or more communication protocols. The communication interface 1030 comprises at least one transmitter (Tx) and at least one receiver (Rx) that may be integrated to the apparatus 1000 or that the apparatus 1000 may be connected to. The communication interface 1030 may provide means for performing some of the blocks for one or more example embodiments described above. The communication interface 1030 may comprise one or more components, such as: power amplifier, digital front end (DFE), analog-to-digital converter (ADC), digital-to-analog converter (DAC), frequency converter, (de) modulator, and/or encoder/decoder circuitries, controlled by the corresponding controlling units.

The communication interface 1030 provides the apparatus with radio communication capabilities to communicate in the cellular communication system. The communication interface may, for example, provide a radio interface to one or more user devices. The apparatus 1000 may further comprise another interface towards a core network such as the network coordinator apparatus or AMF, and/or to the access nodes of the cellular communication system.

The apparatus 1000 may further comprise a scheduler 1040 that is configured to allocate radio resources. The scheduler 1040 may be configured along with the communication control circuitry 1010 or it may be separately configured.

It is to be noted that the apparatus 1000 may further comprise various components not illustrated in FIG. 10. The various components may be hardware components and/or software components.

As used in this application, the term “circuitry” may refer to one or more or all of the following: a) hardware-only circuit implementations (such as implementations in only analog and/or digital circuitry); and b) combinations of hardware circuits and software, such as (as applicable): i) a combination of analog and/or digital hardware circuit(s) with software/firmware and ii) any portions of hardware processor(s) with software (including digital signal processor(s), software, and memory(ies) that work together to cause an apparatus, such as a mobile phone, to perform various functions); and c) hardware circuit(s) and/or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of example embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (for example procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The embodiments are not limited to the example embodiments described above, but may vary within the scope of the claims. Therefore, all words and expressions should be interpreted broadly, and they are intended to illustrate, not to restrict, the example embodiments.

1.-15. (canceled)

16. An apparatus comprising at least one processor, and at least one memory storing instructions that, when executed by the at least one processor, cause the apparatus at least to:
receive a first indication indicating a first demodulation reference signal (DMRS) sequence initialization offset value for a first network node;
receive a second indication indicating a second DMRS sequence initialization offset value for a second network node;
perform, based on the first DMRS sequence initialization offset value, a first uplink transmission to the first network node; and
perform, based on the second DMRS sequence initialization offset value, a second uplink transmission to the second network node, wherein the first uplink transmission and the second uplink transmission overlap at least partially in time.

17. The apparatus according to claim 16, wherein the first uplink transmission is performed based on a first transmission configuration indicator (TCI) state, and the second uplink transmission is performed based on a second TCI state.

18. The apparatus according to claim 16, wherein the first indication is received via first radio resource control signaling, or first downlink control information, or a first medium access control (MAC) control element (CE), and
wherein the second indication is received via second radio resource control signaling, or second downlink control information, or a second MAC CE.

19. The apparatus according to claim 16, further being caused to:
receive a third indication indicating a third DMRS sequence initialization offset value for the first network node or the second network node; and
overwrite the third DMRS sequence initialization offset value with the first DMRS sequence initialization offset value or the second DMRS sequence initialization offset value.

20. The apparatus according to claim 19, wherein the third indication is received via third radio resource control signaling, third downlink control information, or a third MAC CE.

21. The apparatus according to claim 16, wherein the first uplink transmission comprises a first dynamic grant physical uplink shared channel transmission or a first configured grant physical uplink shared channel transmission, and
wherein the second uplink transmission comprises a second dynamic grant physical uplink shared channel transmission or a second configured grant physical uplink shared channel transmission.

22. A method comprising:
receiving a first indication indicating a first demodulation reference signal (DMRS) sequence initialization offset value for a first network node;
receiving a second indication indicating a second DMRS sequence initialization offset value for a second network node;
performing, based on the first DMRS sequence initialization offset value, a first uplink transmission to the first network node; and
performing, based on the second DMRS sequence initialization offset value, a second uplink transmission to the second network node, wherein the first uplink transmission and the second uplink transmission overlap at least partially in time.

23. The method according to claim 22, wherein the first uplink transmission is performed based on a first transmission configuration indicator (TCI) state, and the second uplink transmission is performed based on a second TCI state.

24. The method according to claim 22, wherein the first indication is received via first radio resource control signaling, or first downlink control information, or a first medium access control (MAC) control element, CE, and
wherein the second indication is received via second radio resource control signaling, or second downlink control information, or a second MAC CE.

25. The method according to claim 22, further comprising:
receiving a third indication indicating a third DMRS sequence initialization offset value for the first network node or the second network node; and
overwriting the third DMRS sequence initialization offset value with the first DMRS sequence initialization offset value or the second DMRS sequence initialization offset value.

26. The method according to claim 25, wherein the third indication is received via third radio resource control signaling, third downlink control information, or a third MAC CE.

27. The method according to claim 22, wherein the first uplink transmission comprises a first dynamic grant physical uplink shared channel transmission or a first configured grant physical uplink shared channel transmission, and
wherein the second uplink transmission comprises a second dynamic grant physical uplink shared channel transmission or a second configured grant physical uplink shared channel transmission.

28. A non-transitory computer readable medium comprising program instructions which, when executed by an apparatus, cause the apparatus to perform at least the following:
receiving a first indication indicating a first demodulation reference signal (DMRS) sequence initialization offset value for a first network node;
receiving a second indication indicating a second DMRS sequence initialization offset value for a second network node;
performing, based on the first DMRS sequence initialization offset value, a first uplink transmission to the first network node; and
performing, based on the second DMRS sequence initialization offset value, a second uplink transmission to the second network node, wherein the first uplink transmission and the second uplink transmission overlap at least partially in time.

29. The non-transitory computer readable medium according to claim 28, wherein the first uplink transmission is performed based on a first transmission configuration indicator (TCI) state, and the second uplink transmission is performed based on a second TCI state.

30. The non-transitory computer readable medium according to claim 28, wherein the first indication is received via first radio resource control signaling, or first downlink control information, or a first medium access control, MAC, control element, CE, and
wherein the second indication is received via second radio resource control signaling, or second downlink control information, or a second MAC CE.

31. The non-transitory computer readable medium according to claim 28, wherein the apparatus is further caused to:
receive a third indication indicating a third DMRS sequence initialization offset value for the first network node or the second network node; and
overwrite the third DMRS sequence initialization offset value with the first DMRS sequence initialization offset value or the second DMRS sequence initialization offset value.

32. The non-transitory computer readable medium according to claim 31, wherein the third indication is received via third radio resource control signaling, third downlink control information, or a third MAC CE.

33. The non-transitory computer readable medium according to claim 28, wherein the first uplink transmission comprises a first dynamic grant physical uplink shared channel transmission or a first configured grant physical uplink shared channel transmission, and
wherein the second uplink transmission comprises a second dynamic grant physical uplink shared channel transmission or a second configured grant physical uplink shared channel transmission.
